(19) United States
(12) Patent Application Publication
(10) Pub. No.: US 2025/0066255 A1
(43) Pub. Date: Feb. 27, 2025

(54) MICROWAVE FERRITE MATERIAL, PREPARATION METHOD THEREFOR AND APPLICATION THEREOF

(71) Applicant: HENGDIAN GROUP DMEGC MAGNETICS CO., LTD, Dongyang City Jinhua, Zhejiang (CN)

(72) Inventors: Feiyu LV, Dongyang City Jinhua, Zhejiang (CN); Yuanzhen WANG, Dongyang City Jinhua, Zhejiang (CN); Likang ZHANG, Dongyang City Jinhua, Zhejiang (CN); Yi XU, Dongyang City Jinhua, Zhejiang (CN)

(21) Appl. No.: 18/688,335

(22) PCT Filed: Aug. 4, 2022
(86) PCT No.: PCT/CN2022/110188

§ 371 Date: Feb. 29, 2024

(30) Foreign Application Priority Data
Sep. 1, 2021 (CN) 202111023866.0

(51) Int. Cl. C04B 35/26; C04B 35/626; C04B 35/64; H01F 1/34; H01F 1/36; H01P 1/38

(52) U.S. Cl. CPC C04B 35/2641; C04B 35/6262; C04B 35/62655; C04B 35/62675; C04B 35/64; H01F 1/344; H01F 1/36; C04B 2235/3208; C04B 2235/3217; C04B 2235/3225; C04B 2235/3239; C04B 2235/3244; C04B 2235/3274; C04B 2235/40; C04B 2235/606; C04B 2235/6562; C04B 2235/6565; C04B 2235/6567; C04B 2235/6585; C04B 2235/661; H01P 1/38

(57) ABSTRACT

Disclosed herein are a microwave ferrite material, a preparation method therefor and an application thereof. According to the microwave ferrite material, Y and Zr are partially replaced with Ca, Fe is partially replaced with Al, and the properties of Ca, Y, Zr, V, Al, and Fe are utilized to make the obtained microwave ferrite material have a proper saturation magnetization, ferromagnetic resonance linewidth, and Curie temperature. At the same time, by using a specific amount of V and Al to cooperatively add, it is ensured that the obtained microwave ferrite material has a loss of no more than 0.5 dB within a temperature range of −55° C. to 125° C. and a frequency band range of 700 MHz to 5 GHz, so that the microwave ferrite material has the characteristics of low loss, high Curie temperature, and low magnetic moment, and the requirements of miniaturization, low loss, and wide frequency of an isolator and a circulator can be realized.

### TECHNICAL FIELD

Embodiments of the present application relate to the technical field of materials, for example, a ferrite material, and especially relate to a microwave ferrite material, a preparation method therefor and an application thereof.

### BACKGROUND

In view of the trend that 5G communication is going to be an important part of the future information infrastructure, the miniaturization and lightweight is particularly vital for circulators and isolators which serve as indispensable devices. The size of various distributed parameter junction circulators, no matter what type, should be significantly reduced with the increase in frequency. It has become a research hotspot of miniaturization about how to effectively reduce the device size to increase the use frequency. However, the related miniaturized lumped parameter circulators have narrow bandwidth and do not meet the broadband requirements of 5G communication.

CN112759380A discloses a microwave ferrite material and a preparation method therefor and an application thereof. The preparation method comprises the following steps: (1) subjecting a transition metal oxide to primary ball milling, primary drying, primary screen and pre-sintering to obtain an intermediate ferrite; and (2) subjecting the intermediate ferrite obtained in step (1) to secondary ball milling, secondary drying, secondary screening, granulating, molding and sintering to obtain the microwave ferrite material; in the method, the transition metal oxide in step (1) comprises yttrium oxide, calcium oxide, iron oxide, vanadium oxide, aluminum oxide and zirconium oxide. Although in a 3.4-3.8 GHz miniaturized circulator the bandwidth of the microwave ferrite material reaches 400 MHz, its 4πMs and Tc need to be further improved, and meanwhile, there is room for ΔH to be further reduced.

CN112358290A discloses a ferrite material and a preparation method therefor and an application thereof. The ferrite material has a chemical formula of Bi_{1.3}Ca_{x+2y}Y_{1.7-x-2y}Fe_{5-x-y}ZrxW_{y}O₁₂, and y is 0.01-1. The preparation method comprises the following steps: (1) mixing and sintering raw materials of the ferrite material to obtain a precursor of the ferrite material; and (2) mixing the precursor of the ferrite material in step (1) again, and performing drying, molding and sintering to obtain the ferrite material. In the ferrite material, the Bi and Ca elements can partially replace the Y element, and the Zr and W elements can partially replace Fe ions; their electromagnetic characteristics and compensation points are used to obtain proper 4πMs, ΔH, Tc and other parameters. However, its ΔH is close to 50 Oe, and the loss is relatively large.

With the rapid increase in communication frequency, the high integration of electronic products has high requirements on the device volume; the market has put forward higher performance requirements for microwave ferrite materials, while the materials prepared by the traditional formulation and process have failed to satisfy the market requirements, and thus there is an urgent need to upgrade the material. Therefore, a microwave ferrite material having low loss and high Curie temperature is required, which enables the circulator to realize miniaturization, low loss, and broadband.

### SUMMARY

The following is a summary of the subject detailed herein. This summary is not intended to limit the scope of the claims.

An embodiment of the present application provides a microwave ferrite material and a preparation method therefor and an application thereof. The microwave ferrite material has the characteristics of low loss, high Curie temperature and low magnetic moment, by which the isolator and circulator can meet the requirements of miniaturization, low loss and broadband.

In a first aspect, an embodiment of the present application provides a preparation method for a microwave ferrite material, and the preparation method comprises:
(1) mixing raw materials according to element proportions of a chemical formula Y_{3-2a-b}Ca_{2a+b}VₐZr_{b}In_{c}Al_{d}Fe_{4.97-a-b-c-d}O₁₂, and performing primary ball milling on an obtained mixture to obtain a primary ball-milled material, wherein 0.3≤a≤0.6, 0.1≤b≤0.4, 0.001≤c≤0.1 and 0.1≤d≤0.3;
(2) drying and screening the primary ball-milled material obtained in step (1) to obtain a dried material;
(3) pre-sintering the dried material obtained in step (2) to obtain a pre-sintered material; (4) performing secondary ball milling on the pre-sintered material obtained in step (3) to obtain a secondary ball-milled material; and
(5) granulating, molding and sintering the secondary ball-milled material obtained in step (4) sequentially to obtain the microwave ferrite material.

An iron-deficiency formulation is selected to mix the raw materials for the preparation method of the present application, and thus the prepared microwave ferrite material has the characteristics of low loss, high Curie temperature and low magnetic moment, by which the isolator and circulator can meet the requirements of miniaturization, low loss and broadband.

Moreover, by adjusting the composition of the microwave Ferrite material in the present application, namely, using Ca to partially replace Y, Zr and V and using Al to partially replace Fe, based on the properties of Ca, Y, Zr, V, Al and Fe, the obtained microwave ferrite material is given proper saturation magnetic induction, ferromagnetic resonance line width and Curie temperature; additionally, the specific amounts of V and Al synergistically added ensure that the loss of the obtained microwave ferrite material is not more than 0.5 dB in the temperature range of −55° C. to 125° C. and the frequency range of 700 MHz to 5 GHz.

Specifically, in Y_{3-2a-b}Ca_{2a+b}VₐZr_{b}In_{c}Al_{d}Fe_{4.97-a-b-c-d}O₁₂, a is 0.3-0.6, such as 0.3, 0.35, 0.4, 0.45, 0.5, 0.55 or 0.6; however, a is not limited to the listed values, and other unlisted values within the numerical range are also applicable, and a is preferably 0.4-0.45.

In Y_{3-2a-b}Ca_{2a+b}VₐZr_{b}In_{c}Al_{d}Fe_{4.97-a-b-c-d}O₁₂, b is 0.1-0.4, such as 0.1, 0.15, 0.18, 0.2, 0.21, 0.24, 0.25, 0.3, 0.35 or 0.4; however, b is not limited to the listed values, and other unlisted values within the numerical range are also applicable, and b is preferably 0.18-0.21.

In Y_{3-2a-b}Ca_{2a+b}VₐZr_{b}In_{c}Al_{d}Fe_{4.97-a-b-c-d}O₁₂, C is 0.001-0.1, such as 0.001, 0.005, 0.01, 0.015, 0.02, 0.05, 0.08 or 0.1; however, c is not limited to the listed values, and other unlisted values within the numerical range are also applicable, and c is preferably 0.01-0.02.

In Y_{3-2a-b}Ca_{2a+b}VₐZr_{b}In_{c}Al_{d}Fe_{4.97-a-b-c-d}O₁₂, d is 0.1-0.3, such as 0.1, 0.15, 0.2, 0.21, 0.24, 0.25 or 0.3; however, d is not limited to the listed values, and other unlisted values within the numerical range are also applicable, and d is preferably 0.2-0.25.

Preferably, when the value of a is about twice that of d, the obtained microwave ferrite material will have the optimum performance.

Preferably, the raw materials of the microwave ferrite material comprise an oxygen-containing compound of Y, an oxygen-containing compound of Ca, an oxygen-containing compound of V, an oxygen-containing compound of Zr, In, an oxygen-containing compound of Al and an oxygen-containing compound of Fe.

Preferably, the raw materials of the microwave ferrite material comprise Y₂O₃, CaCO₃, ZrO₂, Fe₂O₃, V₂O₅, Al₂O₃ and In.

Preferably, the primary ball milling in step (1) comprises wet ball milling.

Preferably, a mass ratio of the raw materials, a solvent and mill balls for the primary ball milling in step (1) is 1:(0.8-1.2):(4-6), such as 1:0.8:6, 1:0.9:5.5, 1:1:5, 1:1.1:4.5 or 1:1.2:4; however, the mass ratio is not limited to the listed values, and other unlisted values within the numerical range are also applicable.

The solvent used for the primary ball milling of the present application is the conventional solvent in the art, including but not limited to water and/or anhydrous ethanol.

Preferably, the mill balls used for the primary ball milling in step (1) comprise zirconia balls.

Preferably, the primary ball milling in step (1) has a rotation speed of 40-80 r/min, such as 40 r/min, 45 r/min, 50 r/min, 55 r/min, 60 r/min, 65 r/min, 70 r/min, 75 r/min or 80 r/min; however, the rotation speed is not limited to the listed values, and other unlisted values within the numerical range are also applicable, and the rotation speed is preferably 50-70 r/min.

Preferably, the primary ball milling in step (1) has a time of 25-35 h, such as 25 h, 26 h, 27 h, 28 h, 29 h, 30 h, 31 h or 32 h; however, the time is not limited to the listed values, and other unlisted values within the numerical range are also applicable, and the time is preferably 28-32 h.

By the primary ball milling of the present application, the obtained primary ball-milled material has a median particle size X500f 0.9-1 μm, such as 0.9 μm, 0.92 μm, 0.95 μm, 0.98 μm or 1 μm; however, the median particle size is not limited to the listed values, and other unlisted values within the numerical range are also applicable. Such median particle size facilitates the subsequent drying and screening steps and also guarantees the preparation method proceeding steadily.

Preferably, the drying in step (2) has a temperature of 120-160° C., such as 120° C., 130° C., 140° C., 150° C. or 160° C.; however, the temperature is not limited to the listed values, and other unlisted values within the numerical range are also applicable, and the temperature is preferably 130-150° C.

Preferably, the drying in step (2) has a time of 12-20 h, such as 12 h, 13 h, 14 h, 15 h, 16 h, 17 h, 18 h, 19 h or 20 h; however, the time is not limited to the listed values, and other unlisted values within the numerical range are also applicable, and the time is preferably 14-16 h.

Preferably, the screening is performed with a sieve of 40-100 mesh; the sieve used for the screening in step (2) has a size of 40-100 mesh, such as 40 mesh, 50 mesh, 60 mesh, 70 mesh, 80 mesh, 90 mesh or 100 mesh; however, the size is not limited to the listed values, and other unlisted values within the numerical range are also applicable.

By the screening in step (2) in the present application, the material with large particle size can be screened off, reducing the energy consumption for the pre-sintering, and improving the pre-sintering efficiency.

Preferably, the pre-sintering in step (3) has a heating rate of 1-2° C./min, such as 1° C./min, 1.2° C./min, 1.5° C./min, 1.6° C./min, 1.8° C./min or 2° C./min; however, the heating rate is not limited to the listed values, and other unlisted values within the numerical range are also applicable, and preferably the heating rate is 1.2-1.6° C./min

Preferably, the pre-sintering in step (3) has a temperature of 1100-1200° C., such as 1100° C., 1110° C., 1120° C., 1130° C., 1140° C., 1150° C., 1160° C., 1170° C., 1180° C., 1190° C. or 1200° C.; however, the temperature is not limited to the listed values, and other unlisted values within the numerical range are also applicable, and the temperature is preferably 1120-1180° C.

Preferably, the pre-sintering in step (3) has a time of 6-10 h, such as 6 h, 7 h, 8 h, 9 h or 10 h; however, the time is not limited to the listed values, and other unlisted values within the numerical range are also applicable, and the time is preferably 7-9 h.

Preferably, furnace cooling is performed after the pre-sintering in step (3) to obtain the pre-sintered material.

Preferably, oxygen introduction is performed when the temperature of the pre-sintering in step (3) reaches more than or equal to 500° C., and the oxygen introduction has an oxygen flow rate of 20-40 L/min, and preferably 25-35 L/min.

The oxygen-introducing temperature of the pre-sintering in step (3) is more than or equal to 500° C., such as 500° C., 510° C., 520° C., 530° C., 540° C. or 550° C.; however, the oxygen-introducing temperature is not limited to the listed values, and other unlisted values within the numerical range are also applicable.

The flow rate of the oxygen introduction is 20-40 L/min, such as 20 L/min, 25 L/min, 30 L/min, 35 L/min or 40 L/min; however, the flow rate is not limited to the listed values, and other unlisted values within the numerical range are also applicable.

Preferably, the secondary ball milling in step (4) is wet ball milling.

Preferably, a mass ratio of the pre-sintered material, a solvent and mill balls for the secondary ball milling in step (4) is 1:(0.8-1.2):(4-6).

The solvent used for the secondary ball milling of the present application is the conventional solvent in the art, including but not limited to water and/or anhydrous ethanol.

Preferably, the mill balls used for the secondary ball milling in step (4) comprise zirconia balls.

Preferably, the secondary ball milling in step (4) has a rotation speed of 60-80 r/min, such as 60 r/min, 65 r/min, 70 r/min, 75 r/min or 80 r/min; however, the rotation speed is not limited to the listed values, and other unlisted values within the numerical range are also applicable, and the rotation speed is preferably 65-75 r/min.

Preferably, the secondary ball milling in step (4) has a time of 28-32 h, such as 28 h, 29 h, 30 h, 31 h or 32 h; however, the time is not limited to the listed values, and other unlisted values within the numerical range are also applicable, and the time is preferably 29-31 h.

With the above conditions of the secondary ball milling of the present application, the obtained secondary ball-milled material has a median particle size X50 of 0.5-1 μm, such as 0.5 μm, 0.6 μm, 0.7 μm, 0.8 μm, 0.9 μm or 1 μm; however, the median particle size is not limited to the listed values, and other unlisted values within the numerical range are also applicable.

Preferably, the preparation method further comprises drying and sieving sequentially between the secondary ball milling and the granulating in step (4).

Preferably, the drying has a temperature of 100-150° C., such as 100° C., 110° C., 120° C., 130° C., 140° C. or 150° C.; however, the temperature is not limited to the listed values, and other unlisted values within the numerical range are also applicable, and the temperature is preferably 110-130° C.

Preferably, the drying has a time of 12-20 h, such as 12 h, 13 h, 14 h, 15 h, 16 h, 17 h, 18 h, 19 h or 20 h; however, the time is not limited to the listed values, and other unlisted values within the numerical range are also applicable, and the time is preferably 15-18 h.

Preferably, the screening is performed with a sieve of 40-80 mesh; the sieve used for the screening has a size of 40-80 mesh, such as 40 mesh, 50 mesh, 60 mesh, 70 mesh or 80 mesh; however, the size is not limited to the listed values, and other unlisted values within the numerical range are also applicable.

In the present application, the drying and sieving sequentially performed between the secondary ball milling and the granulating guarantees the molding density of the molded material, satisfying the actual application requirements.

Preferably, the molding has a molding density of 3.4-3.6 g/cm³, such as 3.4 g/cm³, 3.45 g/cm³, 3.5 g/cm³, 3.55 g/cm³ or 3.6 g/cm³; however, the molding density is not limited to the listed values, and other unlisted values within the numerical range are also applicable.

Preferably, the sintering in step (5) comprises a heating stage, a heat preserving stage and a cooling stage which are performed sequentially, wherein the heating stage comprises at least three heating steps, and the cooling stage comprises at least two cooling steps.

Preferably, the heating stage comprises a first heating, a second heating and a third heating which are performed sequentially.

Preferably, the first heating has a heating rate of 1-2° C./min, such as 1° C./min, 1.2° C./min, 1.5° C./min, 1.6° C./min, 1.8° C./min or 2° C./min; however, the heating rate is not limited to the listed values, and other unlisted values within the numerical range are also applicable, and the heating rate is preferably 1.2-1.8° C./min.

Preferably, the first heating has an endpoint temperature of 480-540° C., such as 480° C., 490° C., 500° C., 510° C., 520° C., 530° C. or 540° C.; however, the endpoint temperature is not limited to the listed values, and other unlisted values within the numerical range are also applicable, and the endpoint temperature is preferably 500-520° C.

Preferably, the second heating has a heating rate of 1.5-2.5° C./min, such as 1.5° C./min, 1.8° C./min, 2° C./min, 2.1° C./min, 2.4° C./min or 2.5° C./min; however, the heating rate is not limited to the listed values, and other unlisted values within the numerical range are also applicable, and the heating rate is preferably 1.8-2.2° C./min.

Preferably, the second heating has an endpoint temperature of 880-920° C., such as 880° C., 885° C., 890° C., 895° C., 900° C., 905° C., 910° C., 915° C. or 920° C.; however, the endpoint temperature is not limited to the listed values, and other unlisted values within the numerical range are also applicable, and the endpoint temperature is preferably 890-910° C.

Preferably, the third heating has a heating rate of 2-3° C./min, such as 2° C./min, 2.1° C./min, 2.4° C./min, 2.5° C./min, 2.7° C./min, 2.8° C./min or 3° C./min; however, the heating rate is not limited to the listed values, and other unlisted values within the numerical range are also applicable, and the heating rate is preferably 2.4-2.8° C./min.

Preferably, the third heating has an endpoint temperature of 1300-1400° C., such as 1300° C., 1310° C., 1320° C., 1330° C., 1340° C., 1350° C., 1360° C., 1370° C., 1380° C., 1390° C. or 1400° C.; however, the endpoint temperature is not limited to the listed values, and other unlisted values within the numerical range are also applicable, and the endpoint temperature is preferably 1320-1360° C.

As a preferred technical solution, the heating rate of the first heating is less than that of the second heating, and the heating rate of the second heating is less than that of the third heating.

Preferably, the heat preserving stage has a time of 15-30 h, such as 15 h, 16 h, 17 h, 18 h, 20 h, 21 h, 24 h, 25 h, 27 h, 28 h or 30 h; however, the time is not limited to the listed values, and other unlisted values within the numerical range are also applicable, and the time is preferably 18-25 h.

Preferably, the cooling stage comprises a first cooling and a second cooling which are performed sequentially.

Preferably, the first cooling has a cooling rate of 2-3° C./min, such as 2° C./min, 2.1° C./min, 2.4° C./min, 2.5° C./min, 2.7° C./min, 2.8° C./min or 3° C./min; however, the cooling rate is not limited to the listed values, and other unlisted values within the numerical range are also applicable, and the cooling rate is preferably 2.4-2.8° C./min.

Preferably, the first cooling has an endpoint temperature of 560-620° C., such as 560° C., 570° C., 580° C., 590° C., 600° C., 610° C. or 620° C., and the endpoint temperature is preferably 580-610° C.

Preferably, the second cooling is furnace cooling.

Preferably, during the sintering in step (5), oxygen introduction begins when the temperature increases to more than or equal to 880° C., and ends when the temperature decreases to less than or equal to 700° C., and the oxygen introduction has an oxygen flow rate of 20-40 L/min, and preferably 25-35 L/min.

The initial oxygen-introducing temperature of the sintering in step (5) is more than or equal to 880° C., such as 880° C., 890° C., 900° C., 910° C. or 920° C.; however, the initial oxygen-introducing temperature is not limited to the listed values, and other unlisted values within the numerical range are also applicable.

The final oxygen-introducing temperature of the sintering in step (5) is less than or equal to 700° C., such as 660° C., 670° C., 680° C., 690° C. or 700° C.; however, the final oxygen-introducing temperature is not limited to the listed values, and other unlisted values within the numerical range are also applicable.

As a preferred technical solution of the preparation method according to the first aspect of the present application, the preparation method comprises the following steps:
a. mixing raw materials according to element proportions of a chemical formula Y_{3-2a-b}Ca_{2a+b}VₐZr_{b}In_{c}Al_{d}Fe_{4.97-a-b-c-d}O₁₂, and performing primary ball milling on an obtained mixture for 25-35 h at a rotation speed of 40-80 r/min to obtain a primary ball-milled material, wherein 0.3≤a≤0.6, 0.1≤b≤0.4, 0.001≤c≤0.1 and 0.1≤d≤0.3;
b. drying the primary ball-milled material obtained in step (1) at 120-160° C. for 12-20 h and screening it with a sieve of 40-100 mesh to obtain a dried material;
c. performing heating to raise the temperature to 1100-1200° C. at a heating rate of 1-2° C./min, and pre-sintering the dried material obtained in step (2) for 6-10 h to obtain a pre-sintered material; oxygen introduction is performed when the temperature of the pre-sintering in step (3) reaches more than or equal to 500° C., and the oxygen introduction has an oxygen flow rate of 20-40 L/min;
d. performing secondary ball milling on the pre-sintered material obtained in step (3) for 28-32 h at a rotation speed of 60-80 r/min, and drying it at 100-150° C. for 12-20 h and screening with a sieve of 40-80 mesh to obtain a secondary ball-milled material; and
e. granulating, molding and sintering the secondary ball-milled material obtained in step (4) sequentially to obtain the microwave ferrite material; the molding has a molding density of 3.4-3.6 g/cm³; during the sintering, oxygen introduction begins when the temperature increases to more than or equal to 880° C., and ends when the temperature decreases to less than or equal to 700° C., and the oxygen introduction has an oxygen flow rate of 20-40 L/min;
   the sintering comprises a first heating, a second heating, a third heating, 15-30 hours of heat preserving, a first cooling and a second cooling which are performed sequentially; the first heating raises the temperature to 480-540° C. at a heating rate of 1-2° C./min; the second heating raises the temperature to 880-920° C. at a heating rate of 1.5-2.5° C./min; the third heating raises the temperature to 1300-1400° C. at a heating rate of 2-3° C./min; the first cooling reduces the temperature to 560-620° C. at a cooling rate of 2-3° C./min; the second cooling is furnace cooling.

In a second aspect, an embodiment of the present application provides a microwave ferrite material obtained by the preparation method according to the first aspect.

In a third aspect, an embodiment of the present application provides an application of the microwave ferrite material according to the second aspect in a 5G circulator.

Compared with the related art, the embodiments of the present application have the following beneficial effect:
by specifically configuring the elements of the microwave ferrite material in the embodiments of the present application, when the obtained microwave ferrite material is applied to the 5G circulator, the loss is lower than 0.5 dB in the temperature range of −55° C. to 125° C. and the frequency range of 700 MHz to 5 GHz.

Other aspects will become apparent upon reading and understanding the drawings and detailed description.

### BRIEF DESCRIPTION OF DRAWINGS

The accompanying drawings provide a further understanding of the technical solutions herein, constitute a part of the specification, and explain the technical solutions herein in conjunction with examples of the present application, but should not be construed as limiting the technical solutions herein.

FIG. 1 is an SEM image of a microwave ferrite material obtained in Example 1;

FIG. 2 is an SEM image of a microwave ferrite material obtained in Example 17.

### DETAILED DESCRIPTION

The technical solutions of the present application are further explained below through the specific examples. It should be apparent to those skilled in that art that the examples are merely used for a better understanding of the present application and should not be construed as a specific limitation to the present application.

### Example 1

This example provides a preparation method for a microwave ferrite material, and the preparation method comprises the following steps:
a. raw materials were mixed according to element proportions of the chemical formula Y_{3-2a-b}Ca_{2a+b}VₐZr_{b}In_{c}Al_{d}Fe_{4.97-a-b-c-d}O₁₂, and the obtained mixture was subjected to primary ball milling for 30 h at a rotation speed of 60 r/min to obtain a primary ball-milled material with a median particle size X50 of 0.9-1 μm; the raw materials included Y₂O₃, CaCO₃, ZrO₂, Fe₂O₃, V₂O₅, Al₂O₃ and In; a mass ratio of the raw materials, deionize water and zirconia balls for the primary ball milling was 1:1:5; in the chemical formula, a was 0.42, b was 0.2, c was 0.015, and d was 0.21;
b. the primary ball-milled material obtained in step (1) was dried at 140° C. for 15 h, and screened with a 60-mesh sieve to obtain a dried material;
c. heating was performed to raise the temperature to 1150° C. at a heating rate of 1.5° C./min, and the dried material obtained in step (2) was pre-sintered for 8 h, and cooled to room temperature inside the furnace to obtain a pre-sintered material; oxygen introduction was performed when the temperature of the pre-sintering in step (3) increased to 500° C., and the oxygen introduction had an oxygen flow rate of 30 L/min;
d. the pre-sintered material obtained in step (3) was subjected to secondary ball milling for 30 h at a rotating speed of 70 r/min, dried at 120° C. for 16 h, and screened with a 50-mesh sieve to obtain a secondary ball-milled material; and
e. the secondary ball-milled material obtained in step (4) was granulated, molded and sintered sequentially to obtain the microwave ferrite material; the granulation included mixing the secondary ball-milled material with binder PVA with a 10 wt % concentration, wherein an addition amount of the binder PVA was 10% of a total mass after the granulation; the molding had a molding density of 3.5 g/cm³; during the sintering, oxygen introduction began when the temperature increased to 900° C., and ended when the temperature decreased to 680° C., and the oxygen introduction had an oxygen flow rate of 30 L/min;
   the sintering included a first heating, a second heating, a third heating, 20 hours of heat preserving, a first cooling and a second cooling which were performed sequentially; the first heating raised the temperature to 510° C. at a heating rate of 1.5° C./min; the second heating raised the temperature to 900° C. at a heating rate of 2° C./min; the third heating raised the temperature to 1350° C. at a heating rate of 2.5° C./min; the first cooling reduced the temperature to 600° C. at a cooling rate of 2.5° C./min; the second cooling was furnace cooling.

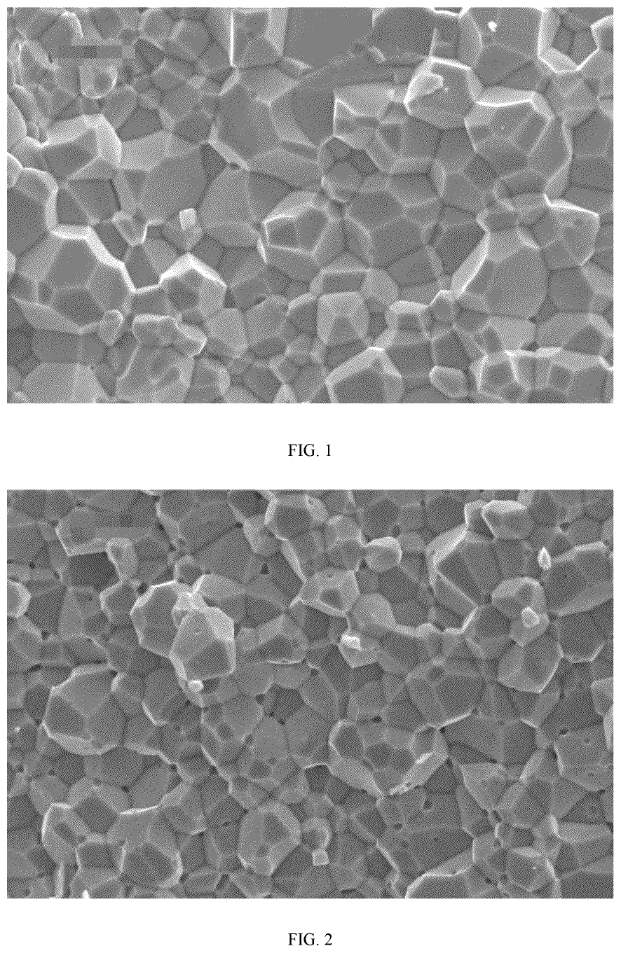

The SEM image of the microwave ferrite material obtained in this example is shown in FIG. 1, and as can be seen from FIG. 1, the microwave ferrite material obtained in this example has a uniform particle size and no generation of pores.

### Example 2

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.4, b was 0.21, c was 0.02, and d was 0.2.

### Example 3

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.5, b was 0.18, c was 0.01, and d was 0.25.

### Example 4

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.5, b was 0.2, c was 0.015, and d was 0.2.

### Example 5

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.4, b was 0.2, c was 0.015, and d was 0.25.

### Example 6

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.6, b was 0.1, c was 0.001, and d was 0.3.

### Example 7

This example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.3, b was 0.4, c was 0.1, and d was 0.1.

### Example 8

This example provides a preparation method for a microwave ferrite material, and the preparation method comprises the following steps:
a. raw materials were mixed according to element proportions of the chemical formula Y_{3-2a-b}Ca_{2a+b}VₐZr_{b}In_{c}Al_{d}Fe_{4.97-a-b-c-d}O₁₂, and the obtained mixture was subjected to primary ball milling for 32 h at a rotation speed of 50 r/min to obtain a primary ball-milled material with a median particle size X50 of 0.9-1 μm; the raw materials included Y₂O₃, CaCO₃, ZrO₂, Fe₂O₃, V₂O₅, Al₂O₃ and In; a mass ratio of the raw materials, deionize water and zirconia balls for the primary ball milling was 1:0.9:5.5; in the chemical formula, a was 0.42, b was 0.2, c was 0.015, and d was 0.21;
b. the primary ball-milled material obtained in step (1) was dried at 130° C. for 16 h, and screened with a 50-mesh sieve to obtain a dried material;
c. heating was performed to raise the temperature to 1120° C. at a heating rate of 1.2° C./min, and the dried material obtained in step (2) was pre-sintered for 9 h, and cooled to room temperature inside the furnace to obtain a pre-sintered material; oxygen introduction was performed when the temperature of the pre-sintering in step (3) increased to 520° C., and the oxygen introduction had an oxygen flow rate of 35 L/min;
d. the pre-sintered material obtained in step (3) was subjected to secondary ball milling for 31 h at a rotating speed of 65 r/min, dried at 110° C. for 18 h, and screened with a 50-mesh sieve to obtain a secondary ball-milled material; and
e. the secondary ball-milled material obtained in step (4) was granulated, molded and sintered sequentially to obtain the microwave ferrite material; the granulation included mixing the secondary ball-milled material with binder PVA with a 9 wt % concentration, wherein an addition amount of the binder PVA was 12% of a total mass after the granulation; the molding had a molding density of 3.5 g/cm³; during the sintering, oxygen introduction began when the temperature increased to 890° C., and ended when the temperature decreased to 690° C., and the oxygen introduction had an oxygen flow rate of 35 L/min;
   the sintering included a first heating, a second heating, a third heating, 25 hours of heat preserving, a first cooling and a second cooling which were performed sequentially; the first heating raised the temperature to 500° C. at a heating rate of 1.2° C./min; the second heating raised the temperature to 890° C. at a heating rate of 1.8° C./min; the third heating raised the temperature to 1320° C. at a heating rate of 2.2° C./min; the first cooling reduced the temperature to 610° C. at a cooling rate of 2.2° C./min; the second cooling was furnace cooling.

### Example 9

This example provides a preparation method for a microwave ferrite material, and the preparation method comprises the following steps:
a. raw materials were mixed according to element proportions of the chemical formula Y_{3-2a-b}Ca_{2a+b}VₐZr_{b}In_{c}Al_{d}Fe_{4.97-a-b-c-d}O₁₂, and the obtained mixture was subjected to primary ball milling for 28 h at a rotation speed of 70 r/min to obtain a primary ball-milled material with a median particle size X50 of 0.9-1 μm; the raw materials included Y₂O₃, CaCO₃, ZrO₂, Fe₂O₃, V₂O₅, Al₂O₃ and In; a mass ratio of the raw materials, deionize water and zirconia balls for the primary ball milling was 1:1.1:4.5; in the chemical formula, a was 0.42, b was 0.2, c was 0.015, and d was 0.21;
b. the primary ball-milled material obtained in step (1) was dried at 150° C. for 14 h, and screened with a 80-mesh sieve to obtain a dried material;
c. heating was performed to raise the temperature to 1180° C. at a heating rate of 1.6° C./min, and the dried material obtained in step (2) was pre-sintered for 7 h, and cooled to room temperature inside the furnace to obtain a pre-sintered material; oxygen introduction was performed when the temperature of the pre-sintering in step (3) increased to 550° C., and the oxygen introduction had an oxygen flow rate of 25 L/min;
d. the pre-sintered material obtained in step (3) was subjected to secondary ball milling for 29 h at a rotating speed of 75 r/min, dried at 130° C. for 15 h, and screened with a 50-mesh sieve to obtain a secondary ball-milled material; and
e. the secondary ball-milled material obtained in step (4) was granulated, molded and sintered sequentially to obtain the microwave ferrite material; the granulation included mixing the secondary ball-milled material with binder PVA with a 1 wt % concentration, wherein an addition amount of the binder PVA was 8% of a total mass after the granulation; the molding had a molding density of 3.5 g/cm³; during the sintering, oxygen introduction began when the temperature increased to 910° C., and ended when the temperature decreased to 670° C., and the oxygen introduction had an oxygen flow rate of 25 L/min;
   the sintering included a first heating, a second heating, a third heating, 18 hours of heat preserving, a first cooling and a second cooling which were performed sequentially; the first heating raised the temperature to 520° C. at a heating rate of 1.8° C./min; the second heating raised the temperature to 910° C. at a heating rate of 2.4° C./min; the third heating raised the temperature to 1360° C. at a heating rate of 2.8° C./min; the first cooling reduced the temperature to 580° C. at a cooling rate of 2.8° C./min; the second cooling was furnace cooling.

### Example 10

This example provides a preparation method for a microwave ferrite material, and the preparation method comprises the following steps:
a. raw materials were mixed according to element proportions of the chemical formula Y_{3-2a-b}Ca_{2a+b}VₐZr_{b}In_{c}Al_{d}Fe_{4.97-a-b-c-d}O₁₂, and the obtained mixture was subjected to primary ball milling for 35 h at a rotation speed of 40 r/min to obtain a primary ball-milled material with a median particle size X50 of 0.9-1 μm; the raw materials included Y₂O₃, CaCO₃, ZrO₂, Fe₂O₃, V₂O₅, Al₂O₃ and In; a mass ratio of the raw materials, deionize water and zirconia balls for the primary ball milling was 1:0.8:6; in the chemical formula, a was 0.42, b was 0.2, c was 0.015, and d was 0.21;
b. the primary ball-milled material obtained in step (1) was dried at 120° C. for 20 h, and screened with a 40-mesh sieve to obtain a dried material;
c. heating was performed to raise the temperature to 1100° C. at a heating rate of 1° C./min, and the dried material obtained in step (2) was pre-sintered for 10 h, and cooled to room temperature inside the furnace to obtain a pre-sintered material; oxygen introduction was performed when the temperature of the pre-sintering in step (3) increased to 500° C., and the oxygen introduction had an oxygen flow rate of 20 L/min;
d. the pre-sintered material obtained in step (3) was subjected to secondary ball milling for 32 h at a rotating speed of 60 r/min, dried at 100° C. for 20 h, and screened with a 40-mesh sieve to obtain a secondary ball-milled material; and
e. the secondary ball-milled material obtained in step (4) was granulated, molded and sintered sequentially to obtain the microwave ferrite material; the granulation included mixing the secondary ball-milled material with binder PVA with a 10 wt % concentration, wherein an addition amount of the binder PVA was 10% of a total mass after the granulation; the molding had a molding density of 3.4 g/cm³; during the sintering, oxygen introduction began when the temperature increased to 880° C., and ended when the temperature decreased to 660° C., and the oxygen introduction had an oxygen flow rate of 20 L/min;
   the sintering included a first heating, a second heating, a third heating, 30 hours of heat preserving, a first cooling and a second cooling which were performed sequentially; the first heating raised the temperature to 480° C. at a heating rate of 1° C./min; the second heating raised the temperature to 880° C. at a heating rate of 1.5° C./min; the third heating raised the temperature to 1300° C. at a heating rate of 2° C./min; the first cooling reduced the temperature to 620° C. at a cooling rate of 2° C./min; the second cooling was furnace cooling.

### Example 11

This example provides a preparation method for a microwave ferrite material, and the preparation method comprises the following steps:
a. raw materials were mixed according to element proportions of the chemical formula Y_{3-2a-b}Ca_{2a+b}VₐZr_{b}In_{c}Al_{d}Fe_{4.97-a-b-c-d}O₁₂, and the obtained mixture was subjected to primary ball milling for 25 h at a rotation speed of 80 r/min to obtain a primary ball-milled material with a median particle size X50 of 0.9-1 μm; the raw materials included Y₂O₃, CaCO₃, ZrO₂, Fe₂O₃, V₂O₅, Al₂O₃ and In; a mass ratio of the raw materials, deionize water and zirconia balls for the primary ball milling was 1:1.2:4; in the chemical formula, a was 0.42, b was 0.2, c was 0.015, and d was 0.21;
b. the primary ball-milled material obtained in step (1) was dried at 160° C. for 12 h, and screened with a 100-mesh sieve to obtain a dried material;
c. heating was performed to raise the temperature to 1200° C. at a heating rate of 2° C./min, and the dried material obtained in step (2) was pre-sintered for 6 h, and cooled to room temperature inside the furnace to obtain a pre-sintered material; oxygen introduction was performed when the temperature of the pre-sintering in step (3) increased to 500° C., and the oxygen introduction had an oxygen flow rate of 40 L/min;
d. the pre-sintered material obtained in step (3) was subjected to secondary ball milling for 28 h at a rotating speed of 80 r/min, dried at 150° C. for 12 h, and screened with a 80-mesh sieve to obtain a secondary ball-milled material; and
e. the secondary ball-milled material obtained in step (4) was granulated, molded and sintered sequentially to obtain the microwave ferrite material; the granulation included mixing the secondary ball-milled material with binder PVA with a 10 wt % concentration, wherein an addition amount of the binder PVA was 10% of a total mass after the granulation; the molding had a molding density of 3.6 g/cm³; during the sintering, oxygen introduction began when the temperature increased to 920° C., and ended when the temperature decreased to 700° C., and the oxygen introduction had an oxygen flow rate of 40 L/min;
   the sintering included a first heating, a second heating, a third heating, 15 hours of heat preserving, a first cooling and a second cooling which were performed sequentially; the first heating raised the temperature to 540° C. at a heating rate of 2° C./min; the second heating raised the temperature to 920° C. at a heating rate of 2.5° C./min; the third heating raised the temperature to 1400° C. at a heating rate of 3° C./min; the first cooling reduced the temperature to 560° C. at a cooling rate of 3° C./min; the second cooling was furnace cooling.

### Example 12

This example provides a preparation method for a microwave ferrite material, which is the same as in Example 1 except that the pre-sintering in step (3) had a temperature of 1000° C.

### Example 13

This example provides a preparation method for a microwave ferrite material, which is the same as in Example 1 except that the pre-sintering in step (3) had a temperature of 1300° C.

### Example 14

This example provides a preparation method for a microwave ferrite material, which is the same as in Example 1 except that the pre-sintering in step (3) did not have oxygen introduction.

### Example 15

This example provides a preparation method for a microwave ferrite material, which is the same as in Example 1 except that during the sintering in step (5), the third heating had an endpoint temperature of 1450° C.

### Example 16

This example provides a preparation method for a microwave ferrite material, which is the same as in Example 1 except that during the sintering in step (5), the third heating had an endpoint temperature of 1250° C.

### Example 17

This example provides a preparation method for a microwave ferrite material, which is the same as in Example 1 except that the sintering in step (5) did not have oxygen introduction.

The SEM image of the microwave ferrite material obtained in this example is shown in FIG. 2, and as can be seen from FIG. 2, the microwave ferrite material obtained in this example obviously has more pores which will deteriorate the material performance.

### Example 18

This example provides a preparation method for a microwave ferrite material, which is the same as in Example 1 except that the first heating, the second heating and the third heating all had a heating rate of 2° C./min.

### Example 19

This example provides a preparation method for a microwave ferrite material, which is the same as in Example 1 except that the first heating had a heating rate of 2.5° C./min, the second heating had a heating rate of 2° C./min, and the third heating had a heating rate of 1.5° C./min.

### Example 20

This example provides a preparation method for a microwave ferrite material, which is the same as in Example 1 except that the secondary ball milling had a time of 16 h to give a median particle size X50 of 1.2 km.

### Comparative Example 1

This comparative example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.25, b was 0.2, c was 0.015, and d was 0.21.

### Comparative Example 2

This comparative example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.65, b was 0.2, c was 0.015, and d was 0.21.

### Comparative Example 3

This comparative example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.42, b was 0.06, c was 0.015, and d was 0.21.

### Comparative Example 4

This comparative example provides a preparation method for a microwave ferrite material, which is the same as in Example 1 except that in the chemical formula Y_{3-2a-b}Ca_{2a+b}VₐZr_{b}In_{c}Al_{d}Fe_{4.97-a-b-c-d}O₁₂ in step (1), a was 0.42, b was 0.42, c was 0.015, and d was 0.21.

### Comparative Example 5

This comparative example provides a preparation method for a microwave ferrite material, which is the same as in Example 1 except that CaCO₃ in the raw materials in step (1) was replaced with an equimolar amount of ZnO.

### Comparative Example 6

This comparative example provides a preparation method for a microwave ferrite material, which is the same as in Example 1 except that CaCO₃ in the raw materials in step (1) was replaced with an equimolar amount of CuO.

### Comparative Example 7

This comparative example provides a preparation method for a microwave ferrite material, which is the same as in Example 1 except that ZrO₂ in the raw materials in step (1) was replaced with an equimolar amount of SnO₂.

### Comparative Example 8

This comparative example provides a preparation method for a microwave ferrite material, which is the same as in Example 1 except that ZrO₂ in the raw materials in step (1) was replaced with an equimolar amount of TiO₂.

### Comparative Example 9

This comparative example provides a preparation method for a microwave ferrite material, which is the same as in Example 1 except that In in the raw materials in step (1) was replaced with an equimolar amount of Fe.

### Performance Conditions

The microwave ferrite materials provided in Examples 1-20 and Comparative Examples 1-9 are tested for density (ρ), saturation magnetic induction strength (4πMs), Curie temperature (Tc), dielectric constant (ε), and ferromagnetic resonance line width (ΔH); the density is tested by the water displacement method; the saturation magnetic induction strength and the Curie temperature are measured by a vibrating sample magnetometer, and the sample to be measured is processed into a spherical ball with a diameter of 2.5 mm for the measurement; the dielectric constant is tested with reference to Standard 4EC60556, the test frequency is 10.7 GHz and the sample is a φ 1.6 mm×22 mm cylinder; the ferromagnetic resonance line width is tested with reference to Standard GB/T 9633-88, and the sample to be tested is prepared into a spherical ball (Φ 1 mm); the test results are shown in Table 1.

TABLE 1

| | 4πMs | 4πMs | 4πMs | | | | |
|---|---|---|---|---|---|---|---|
| | at 25° C. (Gs) | at −55° C.(Gs) | at 125° C.(Gs) | Tc (° C.) | ΔH (Oe) | ε | ρ (g/cm³) |
| Standard | 950 ± 50 | 1050 ± 50 | 850 ± 50 | >200 | <20 | 14.5 ± 2 | >4.7 g/cm³ |
| Example 1 | 953 | 1051 | 853 | 203 | 15 | 14.52 | 4.85 |
| Example 2 | 948 | 1048 | 848 | 204 | 15 | 14.49 | 4.84 |
| Example 3 | 951 | 1051 | 851 | 203 | 16 | 14.51 | 4.84 |
| Example 4 | 947 | 1047 | 847 | 201 | 18 | 14.47 | 4.86 |
| Example 5 | 945 | 1045 | 845 | 201 | 18 | 14.45 | 4.84 |
| Example 6 | 938 | 1038 | 838 | 204 | 19 | 14.46 | 4.83 |
| Example 7 | 931 | 1031 | 831 | 205 | 19 | 14.49 | 4.84 |
| Example 8 | 949 | 1049 | 849 | 203 | 16 | 14.50 | 4.84 |
| Example 9 | 950 | 1050 | 850 | 201 | 17 | 14.51 | 4.86 |
| Example 10 | 942 | 1042 | 842 | 205 | 17 | 14.42 | 4.85 |
| Example 11 | 943 | 1043 | 843 | 204 | 18 | 14.45 | 4.81 |
| Example 12 | 912 | 1012 | 812 | 205 | 22 | 14.51 | 4.72 |
| Example 13 | 898 | 998 | 798 | 206 | 32 | 14.42 | 4.71 |
| Example 14 | 946 | 1046 | 846 | 206 | 24 | 14.47 | 4.83 |
| Example 15 | 896 | 996 | 796 | 206 | 35 | 14.47 | 4.76 |
| Example 16 | 862 | 962 | 762 | 209 | 49 | 14.58 | 4.69 |
| Example 17 | 945 | 1045 | 845 | 206 | 28 | 14.47 | 4.86 |
| Example 18 | 923 | 1023 | 823 | 204 | 19 | 14.49 | 4.82 |
| Example 19 | 907 | 1007 | 807 | 206 | 21 | 14.43 | 4.83 |
| Example 20 | 904 | 1004 | 804 | 203 | 31 | 14.49 | 4.79 |
| Comparative | 1235 | 1535 | 1035 | 215 | 28 | 14.05 | 4.96 |
| Example 1 | | | | | | | |
| Comparative | 1183 | 1283 | 983 | 211 | 31 | 14.02 | 4.95 |
| Example 2 | | | | | | | |
| Comparative | 1050 | 1250 | 895 | 210 | 25 | 14.38 | 4.86 |
| Example 3 | | | | | | | |
| Comparative | 1128 | 1228 | 992 | 212 | 27 | 14.27 | 4.81 |
| Example 4 | | | | | | | |
| Comparative | 1372 | 1572 | 1172 | 209 | 38 | 14.04 | 4.92 |
| Example 5 | | | | | | | |
| Comparative | 1286 | 1486 | 1086 | 209 | 35 | 14.19 | 4.88 |
| Example 6 | | | | | | | |
| Comparative | 1419 | 1719 | 1219 | 228 | 47 | 14.17 | 4.82 |
| Example 7 | | | | | | | |
| Comparative | 1408 | 1608 | 1208 | 214 | 52 | 15.09 | 4.85 |
| Example 8 | | | | | | | |
| Comparative | 1392 | 1592 | 1192 | 189 | 48 | 14.96 | 4.81 |
| Example 9 | | | | | | | |

In conclusion, by specifically configuring the elements of the microwave ferrite material in the present application, when the obtained microwave ferrite material is applied to the 5G circulator, the variation of 4πMs is not more than 100 Gs in the temperature range of −55° C. to 125° C., and the ΔH (Oe) of the material is less than 20 Oe, and by the matched design of the center conductor in conjunction with the material with basic characteristics guaranteed, the loss of the 5G circulator is lower than 0.5 dB in the frequency band of 700 MHz to 5 GHz.

The applicant has stated that although the specific examples of the present application are described above, the protection scope of the present application is not limited thereto. It should be apparent to those skilled in the art that any changes or substitutions that are obvious to those skilled in the art within the technical scope disclosed in the present application shall fall within the protection scope and disclosure scope of the present application.

What is claimed is:

1. A preparation method for a microwave ferrite material comprising:
(1) mixing raw materials according to element proportions of a chemical formula Y_{3-2a-b}Ca_{2a+b}VₐZr_{b}In_{c}Al_{d}Fe_{4.97-a-b-c-d}O₁₂, and performing primary ball milling on an obtained mixture to obtain a primary ball-milled material, wherein 0.3≤a≤0.6, 0.1≤b≤0.4, 0.001≤c≤0.1 and 0.1≤d≤0.3;
(2) drying and screening the primary ball-milled material obtained in step (1) to obtain a dried material;
(3) pre-sintering the dried material obtained in step (2) to obtain a pre-sintered material;
(4) performing secondary ball milling on the pre-sintered material obtained in step (3) to obtain a secondary ball-milled material; and
(5) granulating, molding and sintering the secondary ball-milled material obtained in step (4) sequentially to obtain the microwave ferrite material.

2. The preparation method according to claim 1, wherein 0.4≤a≤0.45, 0.18≤b≤0.21, 0.01≤c≤0.02 and 0.2≤d≤0.25.

3. The preparation method according to claim 1, wherein the raw materials of the microwave ferrite material comprise an oxygen-containing compound of Y, an oxygen-containing compound of Ca, an oxygen-containing compound of V, an oxygen-containing compound of Zr, In, an oxygen-containing compound of Al and an oxygen-containing compound of Fe.

4. The preparation method according to claim 1, wherein the raw materials of the microwave ferrite material comprise Y₂O₃, CaCO₃, ZrO₂, Fe₂O₃, V₂O₅, Al₂O₃ and In.

5. The preparation method according to claim 1, wherein the primary ball milling in step (1) comprises wet ball milling;
preferably, a mass ratio of the raw materials, a solvent and mill balls for the primary ball milling in step (1) is 1:(0.8-1.2):(4-6);
preferably, the mill balls used for the primary ball milling in step (1) comprise zirconia balls;
preferably, the primary ball milling in step (1) has a rotation speed of 40-80 r/min, and preferably 50-70 r/min;
preferably, the primary ball milling in step (1) has a time of 25-35 h, and preferably 28-32 h.

6. The preparation method according to claim 1, wherein the drying in step (2) has a temperature of 120-160° C., and preferably 130-150° C.;
preferably, the drying in step (2) has a time of 12-20 h, and preferably 14-16 h;
preferably, the screening is performed with a sieve of 40-100 mesh.

7. The preparation method according to claim 1, wherein the pre-sintering in step (3) has a heating rate of 1-2° C./min, and preferably 1.2-1.6° C./min;
preferably, the pre-sintering in step (3) has a temperature of 1100-1200° C., and preferably 1120-1180° C.;
preferably, the pre-sintering in step (3) has a time of 6-10 h, and preferably 7-9 h;
preferably, furnace cooling is performed after the pre-sintering in step (3) to obtain the pre-sintered material;
preferably, oxygen introduction is performed when the temperature of the pre-sintering in step (3) reaches more than or equal to 500° C., and the oxygen introduction has an oxygen flow rate of 20-40 L/min, and preferably 25-35 L/min.

8. The preparation method according to claim 1, wherein the secondary ball milling in step (4) is wet ball milling;
preferably, a mass ratio of the pre-sintered material, a solvent and mill balls for the secondary ball milling in step (4) is 1:(0.8-1.2):(4-6);
preferably, the mill balls used for the secondary ball milling in step (4) comprise zirconia balls;
preferably, the secondary ball milling in step (4) has a rotation speed of 60-80 r/min, and preferably 65-75 r/min;
preferably, the secondary ball milling in step (4) has a time of 28-32 h, and preferably 29-31 h.

9. The preparation method according to claim 1, wherein the preparation method further comprises drying and sieving sequentially between the secondary ball milling and the granulating in step (4);
preferably, the drying has a temperature of 100-150° C., and preferably 110-130° C.;
preferably, the drying has a time of 12-20 h, and preferably 15-18 h;
preferably, the screening is performed with a sieve of 40-80 mesh;
preferably, the molding has a molding density of 3.4-3.6 g/cm³.

10. The preparation method according to claim 1, wherein the sintering in step (5) comprises a heating stage, a heat preserving stage and a cooling stage which are performed sequentially, wherein the heating stage comprises at least three heating steps, and the cooling stage comprises at least two cooling steps.

11. The preparation method according to claim 10, wherein the heating stage comprises a first heating, a second heating and a third heating which are performed sequentially.

12. The preparation method according to claim 1, comprising the following steps:
(1) mixing raw materials according to element proportions of a chemical formula Y_{3-2a-b}Ca_{2a+b}VₐZr_{b}In_{c}Al_{d}Fe_{4.97-a-b-c-d}O₁₂, and performing primary ball milling on an obtained mixture for 25-35 h at a rotation speed of 40-80 r/min to obtain a primary ball-milled material, wherein 0.3≤a≤0.6, 0.1≤b≤0.4, 0.001≤c≤0.1 and 0.1≤d≤0.3;
(2) drying the primary ball-milled material obtained in step (1) at 120-160° C. for 12-20 h and screening it with a sieve of 40-100 mesh to obtain a dried material;
(3) performing heating to raise the temperature to 1100-1200° C. at a heating rate of 1-2° C./min, and pre-sintering the dried material obtained in step (2) for 6-10 h to obtain a pre-sintered material; oxygen introduction is performed when the temperature of the pre-sintering in step (3) reaches more than or equal to 500° C., and the oxygen introduction has an oxygen flow rate of 20-40 L/min;
(4) performing secondary ball milling on the pre-sintered material obtained in step (3) for 28-32 h at a rotation speed of 60-80 r/min, and drying it at 100-150° C. for 12-20 h and screening with a sieve of 40-80 mesh to obtain a secondary ball-milled material; and
(5) granulating, molding and sintering the secondary ball-milled material obtained in step (4) sequentially to obtain the microwave ferrite material; the molding has a molding density of 3.4-3.6 g/cm³; during the sintering, oxygen introduction begins when the temperature increases to more than or equal to 880° C., and ends when the temperature decreases to less than or equal to 700° C., and the oxygen introduction has an oxygen flow rate of 20-40 L/min;
the sintering comprises a first heating, a second heating, a third heating, 15-30 hours of heat preserving, a first cooling and a second cooling which are performed sequentially; the first heating raises the temperature to 480-540° C. at a heating rate of 1-2° C./min; the second heating raises the temperature to 880-920° C. at a heating rate of 1.5-2.5° C./min; the third heating raises the temperature to 1300-1400° C. at a heating rate of 2-3° C./min; the first cooling reduces the temperature to 560-620° C. at a cooling rate of 2-3° C./min; the second cooling is furnace cooling.

13. A microwave ferrite material obtained by the preparation method according to claim 1.

14. (canceled)

15. The preparation method according to claim 11, wherein the first heating has a heating rate of 1-2° C./min, and preferably 1.2-1.8° C./min;
preferably, the first heating has an endpoint temperature of 480-540° C., and preferably 500-520° C.

16. The preparation method according to claim 11, wherein the second heating has a heating rate of 1.5-2.5° C./min, and preferably 1.8-2.2° C./min;
preferably, the second heating has an endpoint temperature of 880-920° C., and preferably 890-910° C.

17. The preparation method according to claim 11, wherein the third heating has a heating rate of 2-3° C./min, and preferably 2.4-2.8° C./min;
preferably, the third heating has an endpoint temperature of 1300-1400° C., and preferably 1320-1360° C.;

18. The preparation method according to claim 10, wherein the heat preserving stage has a time of 15-30 h, and preferably 18-25 h.

19. The preparation method according to claim 10, wherein the cooling stage comprises a first cooling and a second cooling which are performed sequentially;
preferably, the first cooling has a cooling rate of 2-3° C./min, and preferably 2.4-2.8° C./min;
preferably, the first cooling has an endpoint temperature of 560-620° C., and preferably 580-610° C.;
preferably, the second cooling is furnace cooling.

20. The preparation method according to claim 1, wherein during the sintering in step (5), oxygen introduction begins when the temperature increases to more than or equal to 880° C., and ends when the temperature decreases to less than or equal to 700° C., and the oxygen introduction has an oxygen flow rate of 20-40 L/min, and preferably 25-35 L/min.

21. A 5G circulator, comprising the microwave ferrite material according to claim 13.
